(19) United States
(12) Patent Application Publication
(10) Pub. No.: US 2013/0051602 A1
(43) Pub. Date: Feb. 28, 2013

(54) AUDIO OUTPUT DEVICE

(71) Applicant: Koichi Numata, Tokyo (JP)

(72) Inventor: Koichi Numata, Tokyo (JP)

(73) Assignee: SONY CORPORATION, Tokyo (JP)

(21) Appl. No.: 13/587,081

(22) Filed: Aug. 16, 2012

(30) Foreign Application Priority Data
Aug. 31, 2011 (JP) 2011-188255

(51) Int. Cl. H04R 1/02

(52) U.S. Cl. 381/386

(57) ABSTRACT

An audio output device includes: a housing; a speaker provided in the housing; and a support part which is provided in a floating state in the housing and supports an electronic apparatus.

### CROSS-REFERENCE TO RELATED APPLICATION

The present application claims priority from Japanese Patent Application No. JP 2011-188255 filed in the Japanese Patent Office on Aug. 31, 2011, the entire content of which is incorporated herein by reference.

### FIELD

The present technology relates to an audio output device, and particularly, an audio output device of which vibration caused by audio output is restrained from being transmitted to an electronic apparatus connected thereto.

### BACKGROUND

In recent years, a device which is connected to an electronic apparatus such as portable audio reproducing devices, mobile telephones, smartphones, and the like and outputs audio data stored in the electronic apparatus as sound, a so-called dock speaker has become widely used.

Such a dock speaker is mostly configured to include a housing, a speaker that is provided inside the housing facing toward the front and outputs sound, a cradle as a support portion for supporting an electronic apparatus, and a tray (hereinafter, referred to as “cradle, and the like”) (Refer to JP-A-2008-92159).

### SUMMARY

A speaker vibrates as audio outputs, and the vibration is transmitted to the housing of the dock speaker and also to the cradle, and the like supporting an electronic apparatus. In the dock speaker, when a separate support part with a different structure supporting such an electronic apparatus is provided in addition to the cradle, and the like, there is a case where a difference in vibration frequencies occurs between the cradle, and the like and the separate support part, and the difference makes the electronic apparatus vibrate intensely. Since the electronic apparatus is a precision mechanical apparatus, intense vibration for a long period of time can cause malfunction, or the like.

Therefore, it is desirable to provide an audio output device of which vibration caused by audio output is restrained from being transmitted to an electronic apparatus connected thereto.

An embodiment of the present technology is directed to an audio output device including a housing, a speaker provided in the housing, and a support part which is provided in a floating state in the housing and supports an electronic apparatus.

According to the embodiment of the present technology, it is possible to restrain vibration caused by an audio output from being transmitted to a connected electronic apparatus.

### BRIEF DESCRIPTION OF THE DRAWINGS

FIG. 1 is an external perspective view showing an external configuration of a dock speaker as an audio output device according to an embodiment of the present technology;

FIG. 2 is a perspective view showing a state in which an electronic apparatus is connected to the dock speaker as the audio output device according to the embodiment of the present technology;

FIG. 3 is a diagram showing a configuration of the surface side of a housing which constitutes the dock speaker and a support mechanism supporting the electronic apparatus;

FIG. 4 is a diagram showing a configuration of the rear face side of the housing which constitutes the dock speaker and the support mechanism supporting the electronic apparatus;

FIG. 5 is an exploded view of the support mechanism;

FIG. 6 is another exploded view of the support mechanism;

FIG. 7 is a diagram showing a first process for providing the support mechanism in the housing; and

FIG. 8 is a diagram showing a second process for providing the support mechanism in the housing.

### DETAILED DESCRIPTION

Hereinafter, an embodiment of the present technology will be described with reference to drawings.

[1. Embodiment]
[1-1. Configuration of Audio Output Device]
[1-2. Configuration of Support Mechanism]
[1-3. Processes of Installing Support Mechanism]

<2. Modified Example>

### 1 1. EMBODIMENT

### [1-1. Configuration of Audio Output Device]

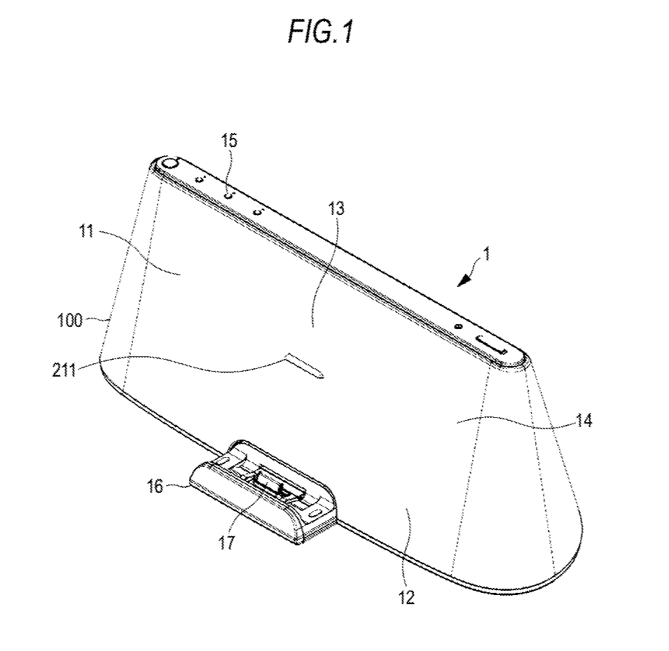

FIG. 1 is a perspective view showing an external configuration of a dock speaker 1 as an audio output device according to an embodiment of the present technology. The dock speaker 1 is constituted by a housing 100, an Lch speaker 11, an Rch speaker 12, a woofer 13, a net 14, an operation unit 15, a cradle part 16, a support mechanism 200 supporting an electronic apparatus 300, and the like. In addition, a control circuit, a reception antenna, a tuner, a storage medium, an audio processing circuit, an amplifier unit, and the like are further provided therein (all of which are not shown in the drawing).

The housing 100 is formed such that both right and left ends become rounder and narrower toward the top portion. However, the shape of housing 100 is not limited thereto, and may have other shapes, for example, a rectangular shape. The housing 100 is made of a synthetic resin such as plastic, or the like, a metal such as aluminum, or the like, and inside the housing, speakers, a control circuit, an audio processing circuit, and the like are provided.

The Lch speaker 11 and the Rch speaker 12 output audio data stored in an electronic apparatus to be connected to the dock speaker 1 as sound. In the dock speaker 1 shown in FIG. 1, the Lch speaker 11 and the Rch speaker 12 are provided in the housing 100 in state of facing the front so that sound can be output from the front side of the housing 100. In the embodiment, the Lch speaker 11 is provided in the left side of the housing when the dock speaker 1 is seen, and the Rch speaker 12 is provided in the right side of the housing when the dock speaker 1 is seen. Furthermore, in the housing between the Lch speaker 11 and the Rch speaker 12, the woofer 13 that is a speaker for low register sound is provided. In addition, the front face side of the housing 100 is covered by a mesh-like material such as the net 14.

The operation unit 15 is constituted by various operational buttons provided on the top face of the housing 100. As the operation unit 15, for example, a power button, a reproduction button, a stop button, a forward button, a rearward button, and the like. When a user presses down one of the buttons and then an input is made to the operation unit 15, a control signal is generated according to the input, and the control signal is output to the control circuit. Then, the control circuit controls the dock speaker 1 according to the control signal.

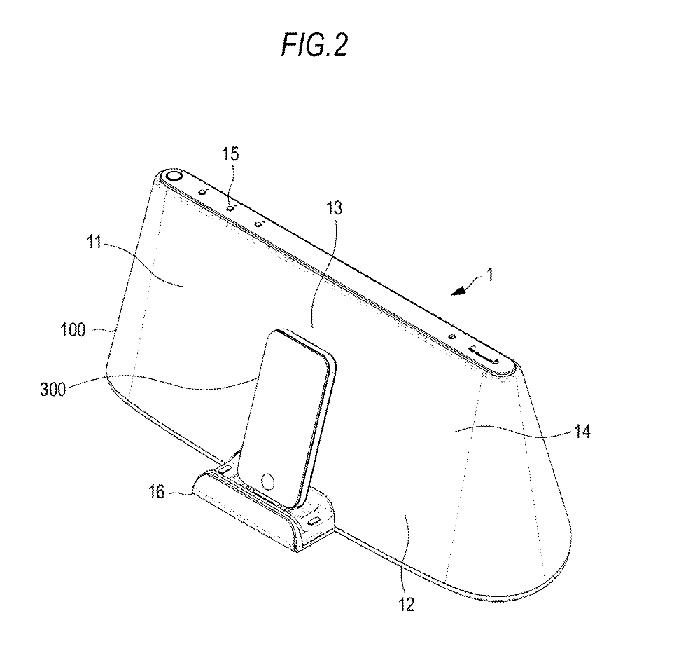

The cradle part 16 supports the electronic apparatus 300 such as a portable music reproducing device, a mobile telephone, a smartphone, a portable game device, a tablet terminal, and the like (hereinafter, collectively referred to as the electronic apparatus 300) to be connected to the dock speaker 1, as shown in FIG. 2. The cradle part 16 includes a connector 17, which is for electrically connecting the electronic apparatus 300 to the dock speaker 1. As shown in FIG. 1, the connector 17 for connection with the electronic apparatus 300 is provided almost at the center of the placement part of the front side of the cradle part 16. Although not shown in the drawings, the connector 17 is connected to the control circuit, the audio processing circuit and the like inside the housing with wiring.

The cradle part 16 includes, for example, a case part incorporated into the housing 100, and the connector 17, and is constituted by a slide part configured to be slidable inside the case. When the cradle part 16 is not used, the slide part can be stored in the housing 100. When the cradle part is used, the connector 17 is exposed outside by the user sliding the slide part of the cradle part 16. Furthermore, the cradle part 16 corresponds to a second support part according to the appended claims. However, the second support part according to the appended claims is not limited to the cradle part 16 shown in FIGS. 1 and 2. Any part is possible if the part supports the electronic apparatus 300 at a position apart from the support mechanism 200. For example, a part may be possible if the part has a tray shape in which the connector 17 is exposed outside at all time.

At substantially the center of the width direction of the front face of the housing 100, a backrest part 211 of a projecting shape supporting the electronic apparatus 300 placed in the cradle part 16 from the back side protrudes. The backrest part 211 is formed as a protrusion with a predetermined length along the width and horizontal direction of the housing 100. The backrest part 211 constitutes the support mechanism 200 supporting the electronic apparatus 300 from the back side. The electronic apparatus 300 is supported not only from the lower side by the cradle part 16 but also from the back side by the backrest part 211. Hence, the electronic apparatus 300 is supported from two different directions. Details of the backrest part 211 and the support mechanism 200 will be described later.

The control circuit is constituted by, for example, a CPU (Central Processing Unit), a RAM (Random Access Memory), and a ROM (Read Only Memory). The CPU performs overall control of the dock speaker 1 by issuing commands to execute various processes according to programs stored in the ROM with the RAM as a working memory.

The tuner is a tuner for terrestrial digital radio broadcasting including a tuning circuit that tunes radio waves received by the reception antenna to the frequency corresponding to a selected channel, a demodulating circuit that performs a demodulation process for signals. The tuner acquires an audio signal from the selected high frequency signal and output the signal to the audio processing unit, and the like. However, such radio function is not a necessary configuration for the dock speaker 1.

The storage medium is a high-capacity storage medium constituted by a non-volatile memory, or the like. The storage unit stores content data such as audio data, and the like.

The audio processing circuit performs a predetermined process such as a decoding process for music data, or the like transmitted from the electronic apparatus, or the like and supplies the result to the amplifier unit. The amplifier unit performs an amplification process for the supplied audio signal and supplies the audio signal to the speakers. Sound that has undergone processing by the audio processing unit, the amplifier unit, and the like is finally output from the speakers.

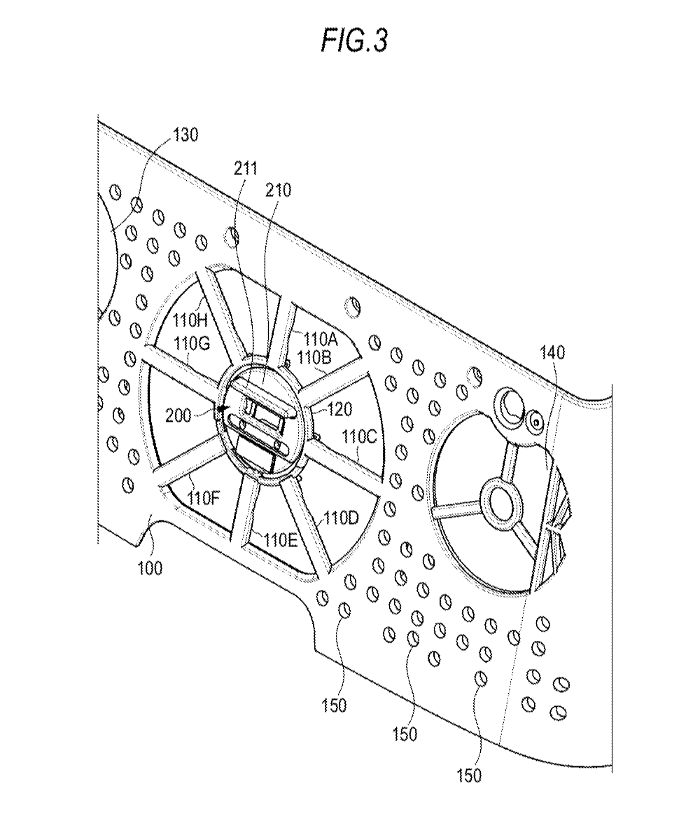

FIG. 3 is a partially enlarged view of the front surface side of the housing 100 constituting the dock speaker 1. At substantially the center of the width direction of the housing 100 is made to be hollow, and eight rod-like ribs 110A, 110B, 110C, 110D, 110E, 110F, 110G, and 110H are formed.

Furthermore, as the portion is set to be hollow, a ring-shape annular rib 120 is provided so as to be connected to the tips of the eight rod-like ribs 110A to 110H. The eight rod-like ribs 110A to 110H are configured to support the annular rib 120. Furthermore, the number of rod-like ribs is not limited to eight. Any number is possible as long as the number of the ribs can assuredly support the annular rib 120 and the support mechanism 200. In the annular rib 120, the support mechanism 200 including the backrest part 211 is provided. The detailed configuration of the support mechanism 200 will be described later.

In addition, as the hollow portions are provided on the front face of the housing 100, an L-side opening part 130 and an R-side opening part 140 are formed at positions respectively corresponding to the Lch speaker 11 and the Rch speaker 12 provided inside the housing 100. Moreover, a plurality of small-diameter holes 150, 150, . . . are provided on the front face of the housing 100. The L-side opening part 130, the R-side opening part 140 and the small-diameter holes 150 are used for outputting the sound from the speakers to the outside of the housing 100.

### [1-2. Configuration of Support Mechanism]

Next, the configuration of the support mechanism 200 provided in the housing 100 will be described. The support mechanism 200 is constituted by a support part 210 including the backrest part 211, and a link part 220 that indirectly links the support part 210 to the housing 100. The support part 210 is provided so as to be positioned inside the annular rib 120. As described above, the support mechanism 200 supports the electronic apparatus 300 placed in the cradle part 16 from the back side as the backrest part 211 projects outside from the front face of the housing 100.

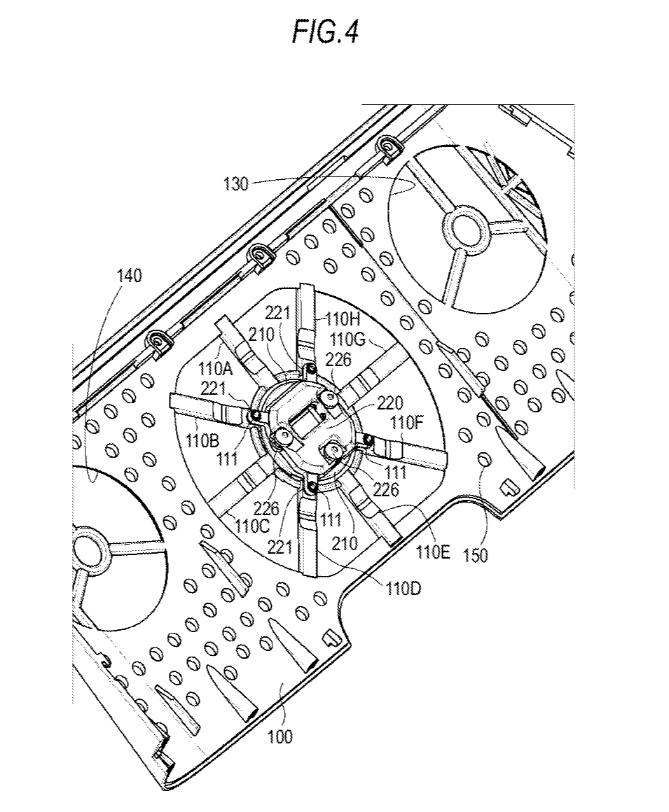

FIG. 4 is a diagram showing a configuration of the inner side of the housing 100. The support part 210 is provided in a floating state via the link part 220 linked to the rod-like ribs 110A to 110H. Herein, the “floating state” refers to a state in which the support part 210 is indirectly connected to the housing 100 via the link part 220 without direct connection to, and even no contact with the housing 100.

Out of eight rod-like ribs 110A to 110H, four rod-like ribs 110 are connected to the link part 220. However, the number of rod-like ribs 110 to be connected to the link part 220 is not limited to four. Any number is possible as long as the number of ribs can support the link part 220 and the support part 210. In this embodiment, the rod-like ribs 110 of the housing 100 are connected to the link part 220, and with the connection of the link part 220 and the support part 210, the housing 100 is indirectly linked to the support part 210.

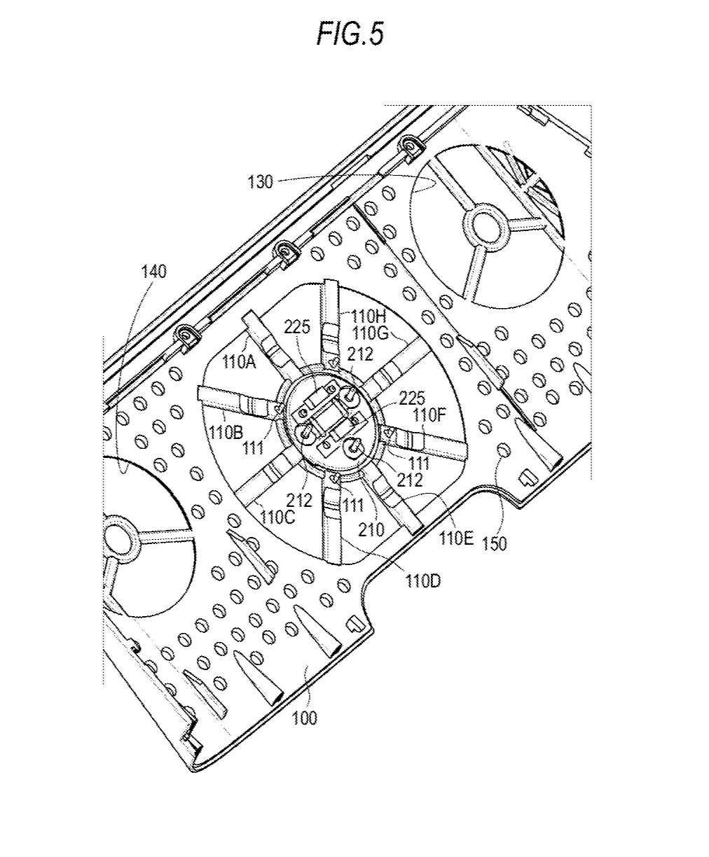

FIG. 5 is a diagram showing configurations of the inner face side of the housing 100 and the rear face side of the support part 210 excluding the link part 220. At the tips of four rod-like ribs 110B, 110D, 110F, and 110H out of the eight rod-like ribs 110A to 110H of the housing 100, link protrusions 111 for linking with the link part 220 are provided.

In the rear face side of the support part 210, connection protrusions 212 for connection with the link part 220 are provided. Furthermore, in the rear face side of the support part 210, two vibration controlling materials 225 in substantially rectangular parallelepiped shapes are provided. The vibration controlling material 225 is a vibration absorbing material, for example, polyethylene, urethane, rubber, or the like. However, any material may be used as long as it fulfills the function of a vibration controlling material. The vibration controlling material 225 plays a role in preventing vibration generated from audio output from the speakers from being transmitted to the support part 210 including the backrest part 211. However, the shape of the vibration controlling material 225 is not limited to the rectangular parallelepiped shape, and the number thereof is also not limited to two. A vibration controlling material, for example, in a sheet form can also be used.

As understood from FIG. 5, the support part 210 does not contact with either rod-like ribs 110A to 110H of the housing 100 or annular rib 120. In the floating state of the support part 210 from the housing 100 as above, it is possible to restrain the vibration from being transmitted to the support part 210 from the housing 100.

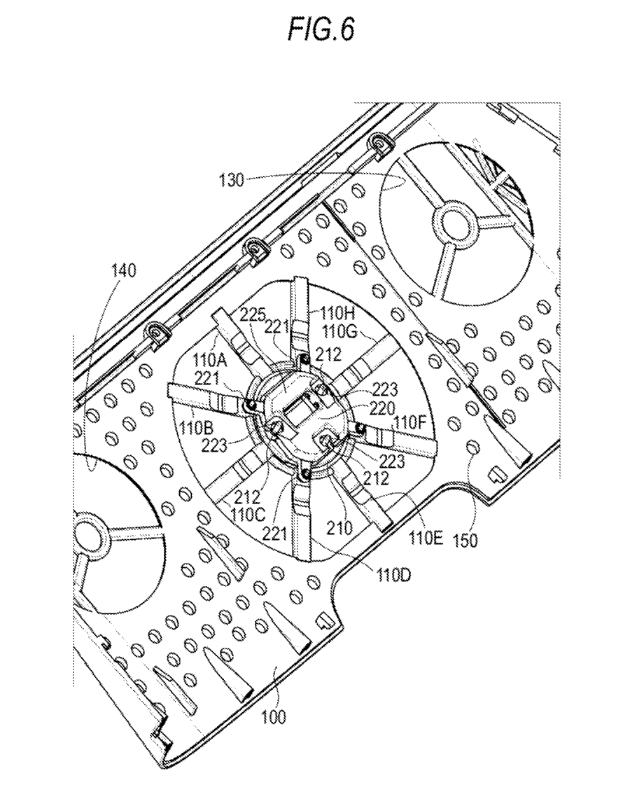

FIG. 6 is a diagram showing a state where the link part 220 is connected to the housing 100. The link part 220 is formed in substantially an octagonal shape so as to cover the rear face side of the support part 210 and the vibration controlling materials 225. However, the shape of the link part 221 does not have to necessarily be an octagonal shape, and may have any other shape such as a circle.

In addition, four link foot parts 221 are provided so as to extend in four inclined directions from the link part 220. The tips of the link foot parts 221 are formed with holes into which the link protrusions 111 of the rod-like ribs 110 are inserted, and by inserting the link protrusions 111 of the rod-like ribs 110 into the holes, the rod-like ribs 110 and the link part 220 are linked.

Furthermore, in the link part 220, three connection holes 223 are formed through which the three connection protrusions 212 provided in the support part 210 pass. As shown in FIG. 6, in the state where the link part 220 is connected to the support part 210, the connection protrusions 212 of the support part 210 project from the connection holes 223.

In addition, as shown in FIG. 4, the support part 210 and the link part 220 are connected to each other by providing insulators 226 for each of the three connection protrusions 212 projecting from the holes in the connection protrusions 212. The insulators 226 fix the link state of the support part 210 and the link part 220, and fills the role of absorbing vibration generated from audio output from the speakers.

As such, the support part 210 supporting the electronic apparatus 300 is provided. As described above, the support part 210 does not come into contact with the housing 100, and furthermore, is not connected directly to the housing 100. Accordingly, vibration caused by audio output from the speakers, or vibration of the housing 100 is barely transmitted to the backrest part 211 included in the support part 210. Therefore, it is possible to lessen vibration of the electronic apparatus 300 connected to the dock speaker 1.

In addition, in the dock speaker 1 according to the embodiment, the woofer 13 that is a speaker for the low register sound is provided substantially at the center. Since the sound of the low register has larger vibration than the sound of the high register, when the electronic apparatus 300 is connected at the front of the dock speaker 1 without taking any measure, the electronic apparatus 300 seriously wobbles due to the influence of vibration caused by the sound of the low register.

Hence, by providing the support mechanism 200 according to the embodiment of the present technology at the position affected by serious vibration, such as in the front or vicinity of the woofer outputting the sound of the low register, it is possible to restrain vibration caused by the sound of the low register from being transmitted to the electronic apparatus 300 and suppress the electronic apparatus 300 from wobbling.

In addition, when the electronic apparatus 300 is supported in two directions of the lower and rear sides, there is a case where a difference between frequencies of vibration in the two directions is made and the difference causes the electronic apparatus 300 to intensely vibrate. Thus, by providing the support mechanism 200 according to the embodiment of the present technology in the rear side which is one of the two directions in which the electronic apparatus 300 is supported, it is possible to restrain wobbling of the electronic apparatus 300.

As shown in the embodiment of the present technology, when the cradle part is constituted by two members of the case part and the slide part that can slide in the case part, vibration in the cradle part is more intense than when the cradle part is constituted by one member. In such a case, by using, separate from the cradle part, the support mechanism causing a little vibration according to the embodiment of the present technology as a support mechanism for supporting the electronic apparatus, it is possible to restrain the electronic apparatus from intensely vibrating.

### [1-3. Processes of Installing Support Mechanism]

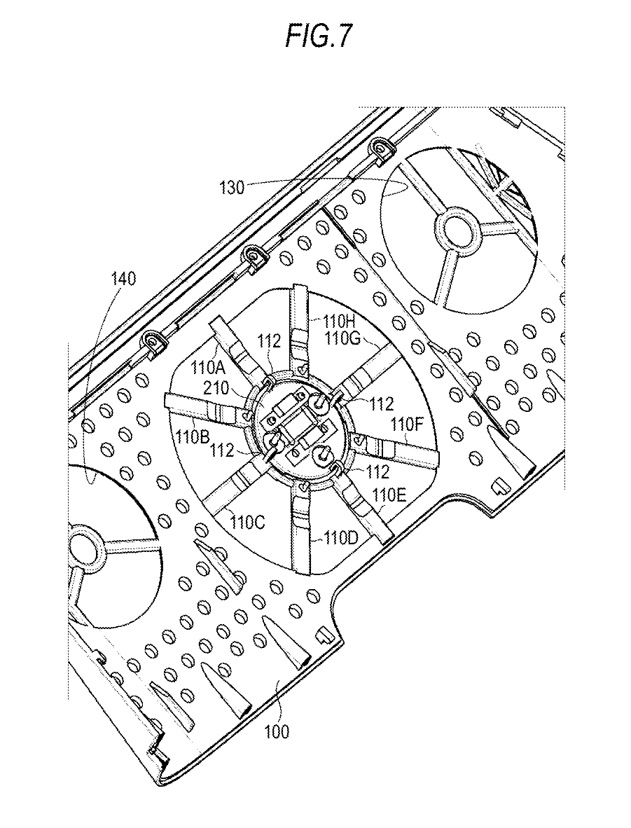

Next, steps of providing the above-described support part 210 and the link part 220 will be described. First, as shown in FIG. 7, the support part 210 is connected to the tips of four rod-like ribs 110A, 110C, 110E, and 110G via U-shaped link parts 112, 112, . . . . Furthermore, the housing 100, the rod-like ribs 110, the U-shaped link parts 112, the annular rib 120, and the support part 210 are not formed as individual members and connected to each other, but connected by being molded in a single unit. However, it may be possible that the rod-like ribs 110A to 110H, the U-shaped link parts 112, the annular rib 120, and the support part 210 are molded in a single unit, and connected to the housing 100 via the rod-like ribs 110A to 110H.

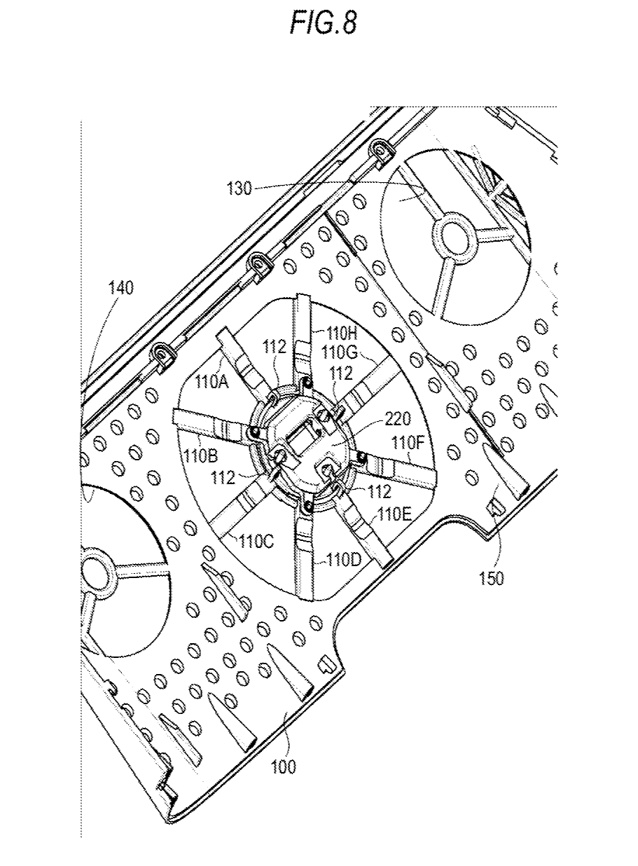

Next, as shown in FIG. 8, the link part 220 and the insulators 226 are provided. Then, after the rod-like ribs 110, the link part 220, and the support part 210 are linked together, the U-shaped link parts 112 are removed by cutting. Accordingly, the rod-like ribs 110A to 110H are not directly connected to the support part 210 including the backrest part 211, but connected via the link part 220. In other words, the support part 210 becomes to be provided in the above-described “floating state”. With the configuration, it is possible to restrain vibration generated from the speakers from being transmitted to the support part 210 including the backrest part 211 passing through the housing 100 and the rod-like ribs 110.

With the above process it is possible to realize the configuration with the support mechanism 200 according to the embodiment of the present technology. However, the process is an example of the process for realizing the configuration with the support mechanism 200 according to the embodiment of the present technology, and not limited thereto. Any other method is possible as long as it can realize the configuration with the support mechanism 200 according to the embodiment of the present technology.

### 2. MODIFIED EXAMPLE

Hereinabove, the embodiment of the present technology has been described in detail, but the present technology is not limited to the above-described embodiment, and can be variously modified based on the technical gist of the present technology. For example, the support part may be configured not only to support the electronic apparatus from the back side in the backrest part of a protrusion shape, but also to support the electronic apparatus by sandwiching the apparatus.

In addition, the present technology may be implemented as the following configurations.

(1) An audio output device including a housing, a speaker provided in the housing, and a support part which is provided in a floating state in the housing and supports an electronic apparatus.

(2) The audio output device according to (1) described above, in which the support part is connected to the housing in the floating state via a link part connected to the housing.

(3) The audio output device according to (1) or (2) described above, in which the support part includes a backrest part for supporting the electronic apparatus from the back side.

(4) The audio output device according to any one of (1) to (3) described above, further including a second support part which is provided at a position apart from the support part in the housing and supports the electronic apparatus.

(5) The audio output device according to any one of (1) to (4) described above, in which the speaker is provided, inside the housing, in the back side of the electronic apparatus supported by the support part.

It should be understood by those skilled in the art that various modifications, combinations, sub-combinations and alterations may occur depending on design requirements and other factors insofar as they are within the scope of the appended claims or the equivalents thereof.

What is claimed is:

1. An audio output device comprising:
a housing;
a speaker provided in the housing; and
a support part which is provided in a floating state in
the housing and supports an electronic apparatus.

2. The audio output device according to claim 1, wherein the support part is connected to the housing in the floating state via a link part connected to the housing.

3. The audio output device according to claim 1, wherein the support part includes a backrest part for supporting the electronic apparatus from the back side.

4. The audio output device according to claim 1, further comprising:
a second support part which is provided at a position apart from the support part in the housing and supports the electronic apparatus.

5. The audio output device according to claim 1, wherein the speaker is provided, inside the housing, in the back side of the electronic apparatus supported by the support part.
